(19) United States
(12) Patent Application Publication
(10) Pub. No.: US 2005/0220530 A1
(43) Pub. Date: Oct. 6, 2005

(54) Portasmile toothbrush with disposable brush and ink cartridge

(76) Inventor: Agustin Carmona, Miami, FL (US)

Correspondence Address: Agustin Carmona, 12914 N.W. 8th Lane, Miami, FL, 33182, US

(21) Appl. No.: 10/813,259

(22) Filed: Mar. 31, 2004

(51) Int. Cl. B43K 5/06; A47L 13/22

(52) U.S. Cl. 401/195; 401/176; 401/270

(57) ABSTRACT

A compact and portable toothbruh/pen and of the type having a housing body (10) with an internal cavity for the transmission of toothpaste to a brush head (16) by means of an air pump (12) and a piston (14) At the distal end is housed a ink pen cartridge (18) covered and kept in place by a cartridge compartment (22) And a cartridge compartment mount (20).

### CROSS-REFERENCE TO RELATED APPLICATIONS

Not Applicable.

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to toothbrushes, specifically to an improved compact and portable toothbrush.

### BACKGROUND OF THE INVENTION

Originally, if one out in public or out at a restrain, after a meal wanted to cleanse his or her teeth. one would have to suffice with flossing or utilizing a toothpick, or just simply rinsing ones mouth out with wu-ter. due to not having a toothbrush and toothpaste handy. there not usually the items One carries on his or her person there not items of easy portability due to the fixation in this day and age for oral hygiene, my product brings solutions to this fixation, and provides a writing instrument all in one.

Objects and Advantages

Accordingly, several objects and advantages of my invention are;
(A) to provide a portable and compact toothbrush;
(B) to provide a toothbrush that dispenses its own toothpaste;
(C) to provide a portable toothbrush that also serves as a pen.

Further object and advantages are to provide a toothbrush that can be used easily and conveniently to cleanse onest teeth. witch is simple to use and manafacture. which has a calibration window to dispense an egual amount of toothpaste every time still further objects and advantages will become apparent from a consideration of the ensuing description and drawings.

### SUMMARY

In accordance with the present invention a portable toothbrush comprises, a toothpaste compartment, a brush, a cap and a ink cartridge.

### DRAWINGS

FIG. 1 shows a perpective view of both sides.

FIG. 2 shows an exploded view.

FIG. 2A to 2L shows various front and back views of the parts.

FIG. 3, 3A show operational illustrations.

FIG. 4 shows an instructional view.

FIG. 5 shows a view of the invention split down the middle.

### DRAWINGS—LIST OF REFERENCE NUMERALS

| | |
|---|---|
| 10 | housing body |
| 10A | pump orifice |
| 10B | male coupling |
| 12 | air pump |
| 14 | piston |
| 16 | brush head |
| 16A | opening |
| 18 | ink pen cartridge |
| 20 | cartridge compartment mount |
| 22 | cartridge compartment |
| 24 | brush cap |

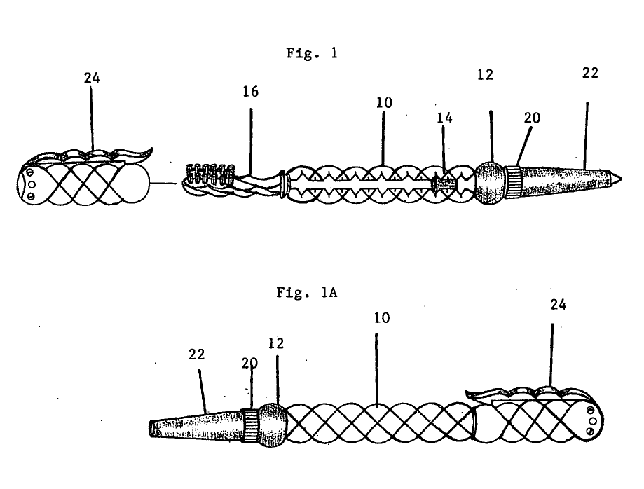

### DETAILED DESCRIPTION—PREFERRED EMBODIMENT—FIGS 1,1A, AND 2

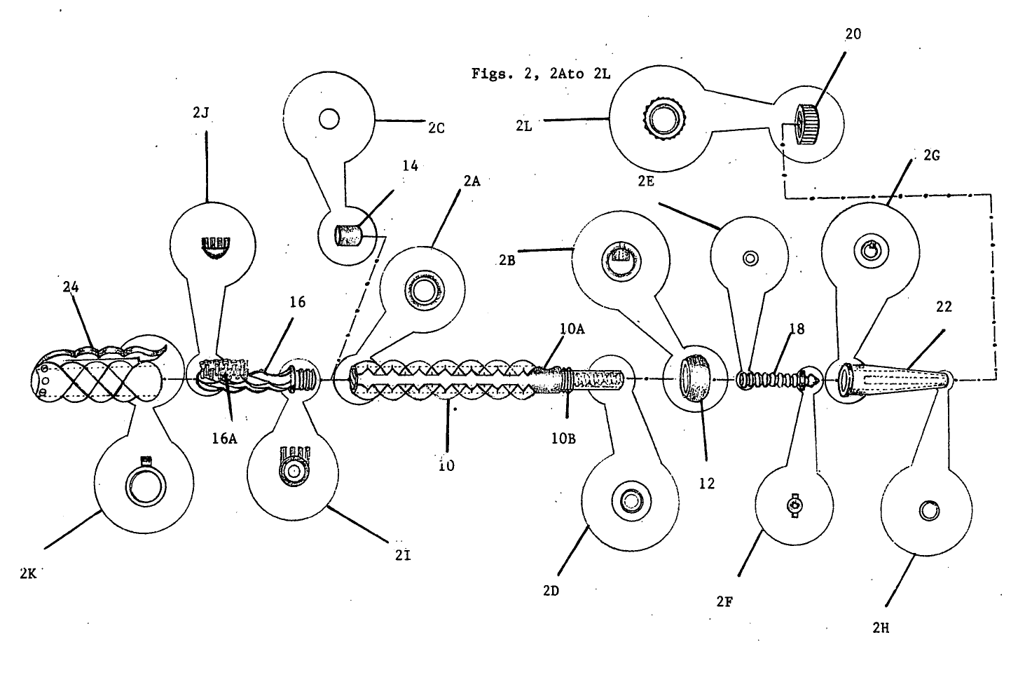

FIG. 1 shows a perspective view of the preferred embodiment of the present invention. A housing body 10 has a cavity running through it with a see through calibration window, a pump orifice 10A, and a male couplig 10B. the housing body 10 also houses a piston 14, a hallow brush head 16 with an opening 16A inbetween bristles at the base of the brush head 16. A brush cap 24 with respitory holes at the top of the cap and a clip along side of the brush cap 24. An air pump 12 slides on throgh the distal end of the housing body 10. the air pumps 12 inner piece as illustrated in (FIG. 2B) goes over pump orifice 10B. Next, one inserts an ink cartridge 18, its followed by the cartridge compartment 22. the ink cartridge 18 has a body with a spiral groove running the length of the body, at the head it has a gib locking pins.

The cartridge compartment 22 at its widest opening face has an outer border. one then slides on a cartridge compartment mount 20, thread side facing inward. the cartridge compartment mount 20 has an inner border that catches the cartridge compartments 22 outer border. By screwing on the cartridge compartment mount 20 to a male coupling 10B on the housing body 10, it locks the cartridge compartment 22 in place.

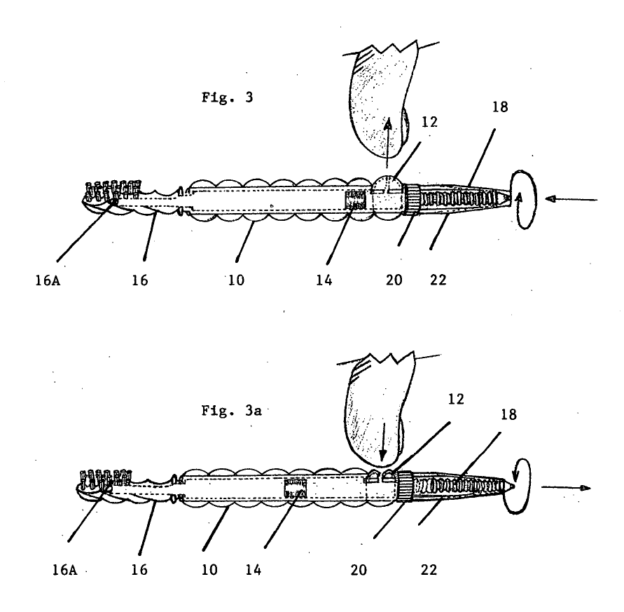

Operation of Invention FIGS. 3,3A and 4

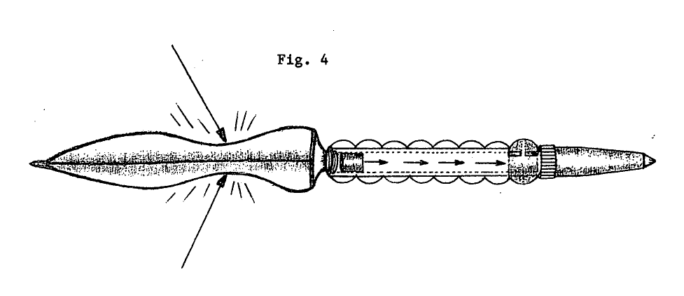

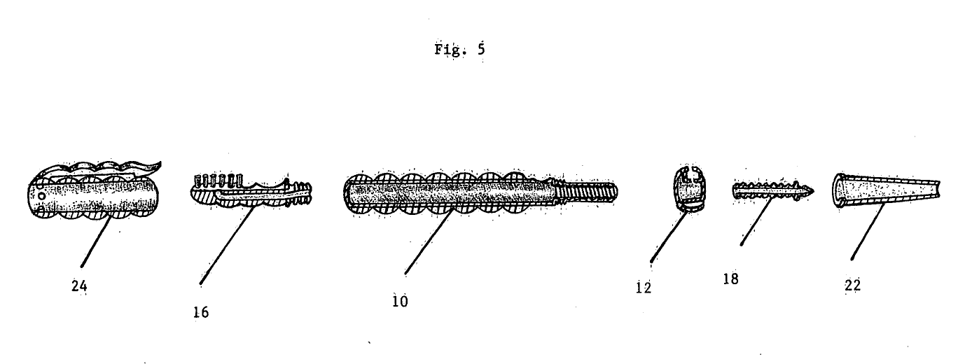

The manner of using the portaSmile is similar to that of toothbrushes in present use. Namely, one first unscrews the brush head 16 from the housing body 10. Next, one screws on a standard tube of toothpaste as illustrated in (FIG. 4). By sgueezing tube of toothpaste it fills the housing body's 10 cavity pushing back the piston to the starting position. then, one unscrews toothpaste tube, screws brush head 16 back on. Its now loaded and ready for use. To use, one simply removes brush cap 24. then, one pushes down the air pump 12 continously as illustrated in (FIG. 3A). Which fills housing body s10 cavity with air that in turn pushes on the piston 14. the piston 14 pushes on toothpaste, which travels the housing body 10 cavity trought the hallow brush head 16, coming out through the opening 16A at the base of the brush head 16.

The housing body 10 has a see through window as illustrated in (FIG. 1), with calibration marks. so one can always use an egual amount of toothpaste. one then cleanses teeth surface as one would with a conventional toothbrush. when one is done cleansing the surface of the teeth, one simply replaces brush cap 24. the brush cap 24 has respitory holes at its top for the airing out and drying of the brush bristles. to use the pen part of the toothbrush one simply turns the cartridge compartment 22 in a clockwise rotation as illustrated in (FIG. 3A). which in turn grips the gibs on the head of the ink cartridge 18.

BY catching the gib it turns along the spiral groove as illustrated in (FIG. 3a). once head of the ink cartridge 18 comes out its ready for use. when one is done, one simply turns cartridge compartment 22 in a counter clock wise rotation as illustrated in (FIG. 3) Until head is in ink compartiment 22.

### Conclusions, Ramifications, and Scope of Invention

Thus the reader will see that the toothbruh of this invention provides a highly reliable, lightweight, compact, yet economical device that can be used by persons of almost any age. and can be clipped and carried in ones pocket, just as one one carry a pen.

1. A portable toothbrush/pen comprising;
(a) a housing body housing a toothpaste transmission system and a disposable hallow brush head;
(b) thereby supplying by means of transmission', toothpaste to said brush head, and
(c) also housing a writting instrument in said housing body.
